(19) United States
(12) Patent Application Publication
(10) Pub. No.: US 2017/0149118 A1
(43) Pub. Date: May 25, 2017

(54) Integrated Structure of Metal Housing and Antenna of Electronic Apparatus

(71) Applicant: Huawei Device Co., Ltd., Shenzhen (CN)

(72) Inventors: Hongyu Wang, Shenzhen (CN); Shuwen Lyu, Shanghai (CN); Xin Zhu, Shanghai (CN); Huimin Zhang, Shenzhen (CN)

(21) Appl. No.: 15/320,836

(22) PCT Filed: Mar. 28, 2014
(86) PCT No.: PCT/CN2014/074273

§ 371 Date: Dec. 21, 2016

(51) Int. Cl. H01Q 1/24

(52) U.S. Cl. CPC H01Q 1/243

(57) ABSTRACT

An integrated structure of a metal housing and an antenna of an electronic apparatus, where the electronic apparatus includes the metal housing and an antenna structure, the antenna structure includes an antenna main body, at least one micro gap set is disposed on the metal housing, the at least one micro gap set includes micro gaps, the at least one micro gap set divides the metal housing to form at least one metal region, and the at least one metal region is connected to the antenna main body to serve as a radiating body of the antenna structure.

### CROSS-REFERENCE TO RELATED APPLICATIONS

This application is a national stage application of international patent application number PCT/CN2014/074273 filed on Mar. 28, 2014, which is incorporated by reference.

### TECHNICAL FIELD

The present disclosure relates to an integrated structure of a metal housing and an antenna of an electronic apparatus.

### BACKGROUND

With the development of science technologies and with an increasingly high requirement of a user on a signal and appearance quality of an electronic product, currently on the market, most electronic products with an antenna, for example, mobile phones, use metal as an exterior housing (including a side, a back cover, and the like), so as to meet a fine textured appearance at the same time of ensuring use intensity. In order to avoid influence on the antenna efficiency and function caused by that a metal housing shields an antenna, the housing is generally designed by combining metal and nonmetal, so that an antenna structure is located in a nonmetal region; or an isolating region made of a nonmetal material is disposed at an end part of the metal housing, and a part of the metal housing close to the antenna is completely isolated from other parts of the metal housing, thereby isolating an antenna region from another region of the metal housing. As shown in FIG. 1, an electronic apparatus 1 includes a metal housing 2 and an antenna 3. An isolation zone 4 is separately disposed at an upper end and a lower end of the metal housing 2, and divides the metal housing 2 into three parts, and a separated region 5 close to the antenna 3 is separated from a middle part of the metal housing 2 without affecting radiation of the antenna. The isolation zone 4 is clearly presented on the housing, resulting in a relatively poor overall effect of the housing; and if the separated region 5 is made into a nonmetal region, and the isolation zone 4 is removed, wholeness and appearance beauty of an electronic product are still affected.

### SUMMARY

Embodiments of the present disclosure provide an integrated structure of a metal housing and an antenna of an electronic apparatus, which can reduce influence on an antenna and ensure appearance integrality of an electronic apparatus.

An integrated structure of a metal housing and an antenna of an electronic apparatus is provided, where the electronic apparatus includes the metal housing and an antenna structure, the antenna structure includes an antenna main body, at least one micro gap set is disposed on the metal housing, the at least one micro gap set includes micro gaps, the at least one micro gap set divides the metal housing to form at least one metal region, and the at least one metal region is connected to the antenna main body to serve as a radiating body of the antenna structure.

An integrated structure of a metal housing and an antenna of an electronic apparatus is provided, where the electronic apparatus includes the metal housing and an antenna structure, the antenna structure includes an antenna main body, at least one micro gap set is disposed on the metal housing, the at least one micro gap set includes micro gaps, the at least one micro gap set divides the metal housing to form at least one metal region, and one metal region of the at least one metal region is connected to ground of a circuit board of the electronic apparatus.

There is one micro gap set, and the micro gap set divides the metal housing into two independent metal regions; and the antenna main body is connected to one of the metal regions.

There are two micro gap sets, and the micro gap sets divide the metal housing to form two metal regions that are completely separated; and the antenna main body is connected to one of the metal regions.

There is one micro gap set, and the micro gap set partially divides the metal housing to form one metal region; and the antenna main body is connected to one side of the micro gap set and is connected to the metal region.

The metal housing is a back cover, a front housing, or a back cover having a metal frame that are of the electronic apparatus, and the micro gap set laterally or longitudinally runs through the metal housing.

The metal housing is a peripheral frame of the electronic apparatus or a peripheral frame connected to a metal back cover, and the two micro gap sets are disposed at intervals to divide the peripheral frame into the two metal regions.

The metal housing is a back cover of the electronic apparatus, a back cover connected to a metal frame, or a peripheral frame.

The antenna structure further includes a matching circuit and a radio frequency transceiver circuit, and the matching circuit is located between the radio frequency transceiver circuit and the antenna main body, and is electrically connected to the radio frequency transceiver circuit and the antenna main body.

The antenna structure further includes a feed point, and the feed point is disposed on the antenna main body.

The micro gap set is formed by arranging the multiple micro gaps at intervals.

The micro gap set is formed by crosswise disposing the multiple micro gaps.

With reference to the tenth or eleventh possible implementation manner of the first aspect, in a twelfth possible implementation manner, a nonmetal material fills between the multiple micro gaps.

A width of the micro gap is less than 0.5 millimeters.

The antenna main body and the metal region may be connected by using a metal dome or connected by using a screw.

In conclusion, according to the integrated structure of a metal housing and an antenna of an electronic apparatus in the present disclosure, a micro gap set including micro gaps is disposed on a metal housing to divide the metal housing, and the divided metal housing is connected to an antenna main body to serve as a radiating body of the antenna main body, thereby implementing an antenna function, which avoids interference of the metal housing on an antenna signal and is beneficial to barely see the gap set from an appearance of the electronic apparatus, thereby not affecting wholeness and appearance beauty of an electronic apparatus that uses the metal housing.

### BRIEF DESCRIPTION OF DRAWINGS

To describe the technical solutions in the embodiments of the present disclosure more clearly, the following briefly introduces the accompanying drawings required for describing the embodiments. The accompanying drawings in the following description show merely some embodiments of the present disclosure, and a person of ordinary skill in the art may still derive other drawings from these accompanying drawings without creative efforts.

FIG. 1 is a schematic diagram of the prior art related to the present disclosure;

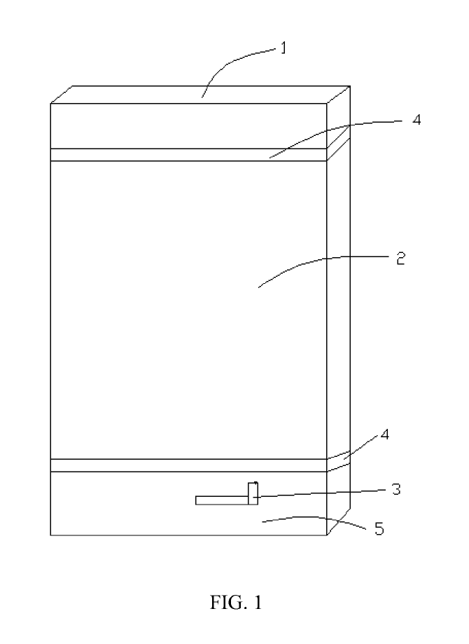

FIG. 2 is a schematic diagram of an electronic apparatus with an integrated structure of a metal housing and an antenna of an electronic apparatus in the present disclosure;

FIG. 2A is a schematic diagram of magnifying a part of a micro gap set II in the integrated structure of a metal housing and an antenna of an electronic apparatus in the present disclosure shown in FIG. 2;

FIG. 3 is a schematic diagram of an integrated structure of a metal housing and an antenna of an electronic apparatus according to a first exemplary embodiment of the present disclosure;

FIG. 4 is a schematic diagram of an integrated structure of a metal housing and an antenna of an electronic apparatus according to a second exemplary embodiment of the present disclosure;

FIG. 5 is a schematic diagram of another form of an integrated structure of a metal housing and an antenna of an electronic apparatus according to a second exemplary embodiment of the present disclosure;

FIG. 6 is a schematic diagram of an integrated structure of a metal housing and an antenna of an electronic apparatus according to a third exemplary embodiment of the present disclosure;

FIG. 7 is a schematic diagram of another form of an integrated structure of a metal housing and an antenna of an electronic apparatus according to a third exemplary embodiment of the present disclosure;

FIG. 8 is a schematic diagram of an integrated structure of a metal housing and an antenna of an electronic apparatus according to a fourth exemplary embodiment of the present disclosure; and

FIG. 9 is a diagram of antenna return loss of the integrated structure, shown in FIG. 2, of a metal housing and an antenna of an electronic apparatus according to the present disclosure.

### DESCRIPTION OF EMBODIMENTS

The following clearly and completely describes the technical solutions in the embodiments of the present disclosure with reference to the accompanying drawings in the embodiments of the present disclosure.

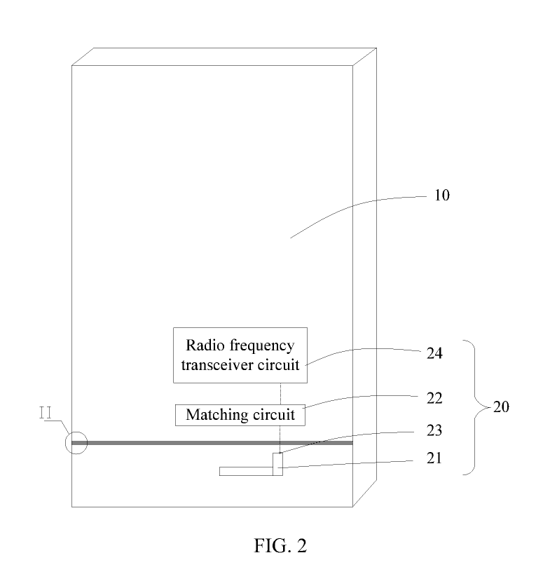

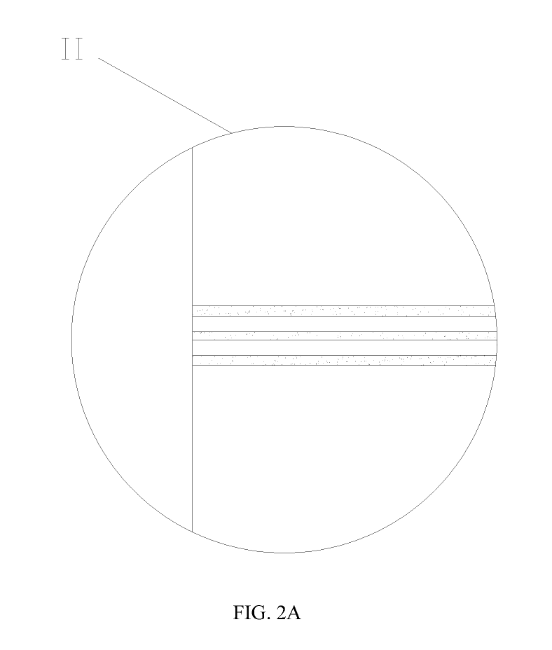

Referring to FIG. 2 and FIG. 2A, an exemplary implementation manner of the present disclosure provides an integrated structure of a metal housing and an antenna of an electronic apparatus, which includes an electronic apparatus 10. The electronic apparatus 10 includes a metal housing (not shown in the figures) and an antenna structure 20. The antenna structure 20 includes an antenna main body 21. At least one micro gap set is disposed on the metal housing. The at least one micro gap set includes micro gaps. The micro gap set divides the metal housing to form at least one metal region, and the at least one metal region is connected to the antenna main body 21 to serve as a radiating body of the antenna main body 21.

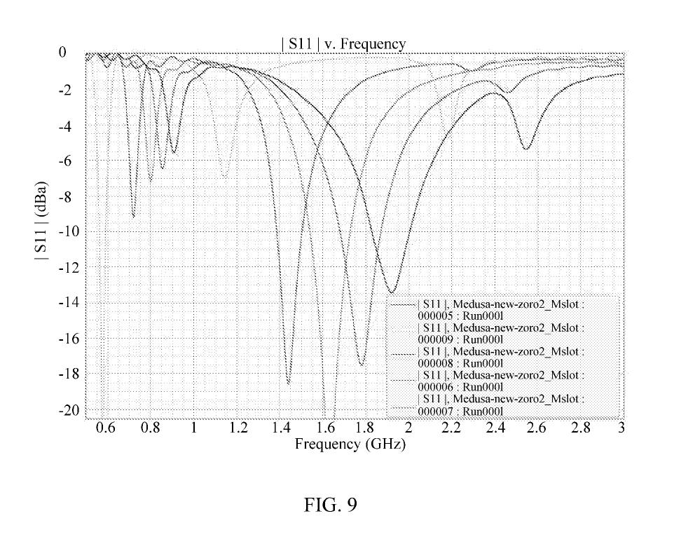

Specifically, the antenna structure 20 further includes a matching circuit 22 and a radio frequency transceiver circuit 24. The matching circuit 22 is located between the radio frequency transceiver circuit 24 and the antenna main body 21, and is electrically connected to the radio frequency transceiver circuit 24 and the antenna main body 21. The matching circuit 22 is used to adjust impedance matching of the loop antenna, so that the antenna main body 21 can better receive a radio frequency signal. The antenna main body 21 and the metal region may be connected by using a metal dome or connected by using a screw. The antenna main body is provided with a feed point 23, where the feed point 23 is disposed on the antenna main body 21. The micro gap may be formed by means of laser cutting, and run through the metal housing. A width of the micro gap is less than 0.5 millimeters, and in this embodiment, preferably, the width is 0.03 millimeters. The micro gap set may include several micro gaps, and the several micro gaps are arranged and disposed at intervals or are crosswise disposed. Referring to FIG. 2A, a nonmetal material may fill between every two micro gaps. FIG. 9 is a diagram of antenna return loss generated by the antenna main body 21 connected to the metal region.

According to the integrated structure of a metal housing and an antenna of an electronic apparatus in the present disclosure, a micro gap set including micro gaps is disposed on a metal housing to divide the metal housing into discontinuous regions; the micro gap set has an isolation effect on an antenna and the metal housing; and the divided metal housing is connected to an antenna main body 21 to serve as a radiating body of the antenna main body 21, thereby implementing an antenna function, which avoids interference of the metal housing on an antenna signal and is beneficial to barely see the gap set from an appearance of the electronic apparatus, thereby not affecting wholeness and appearance beauty of an electronic apparatus 10 that uses the metal housing.

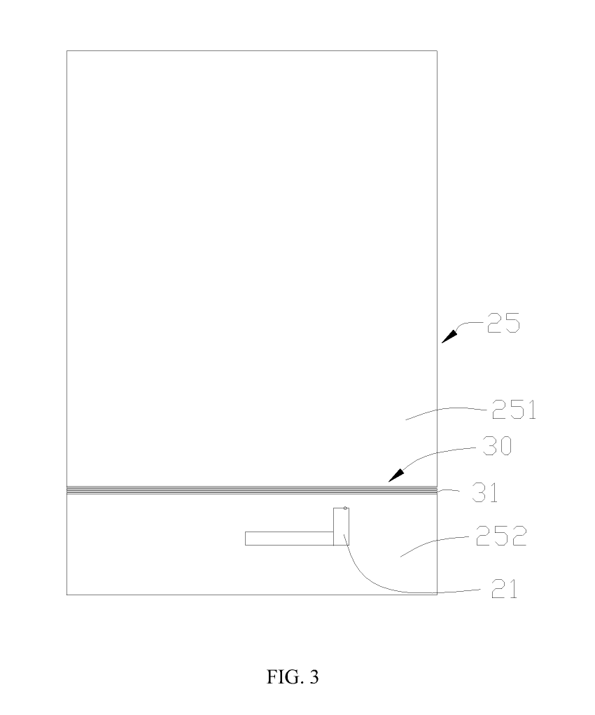

Further, in a first embodiment of the present disclosure, there is one micro gap set, and the micro gap set divides the metal housing into two independent metal regions. Referring to FIG. 3, in this embodiment, the metal housing 25 is a back cover of the electronic apparatus 10, the micro gap set 30 includes more than three micro gaps 31, and the micro gap set 30 laterally runs through the metal housing 25 to divide the metal housing 25 into independent metal regions 251 and 252. The antenna main body 21 is connected to the metal region 251. The metal region 251 serves as a radiating body of the antenna main body 21 to implement an antenna function. In another form of this manner, the metal housing 25 is a back cover connected to a metal peripheral frame, and the micro gap set 30 extends to a position of the metal peripheral frame. The metal housing may further be a front housing of the electronic apparatus. It should be noted that, the micro gap set 30 may further longitudinally run through the metal housing 25.

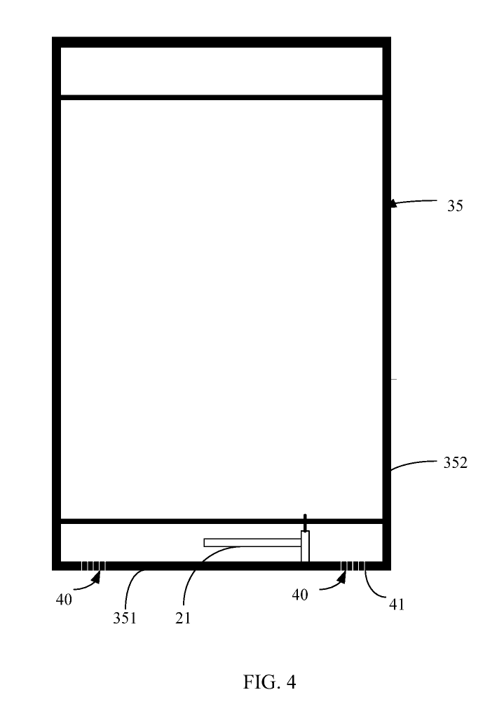

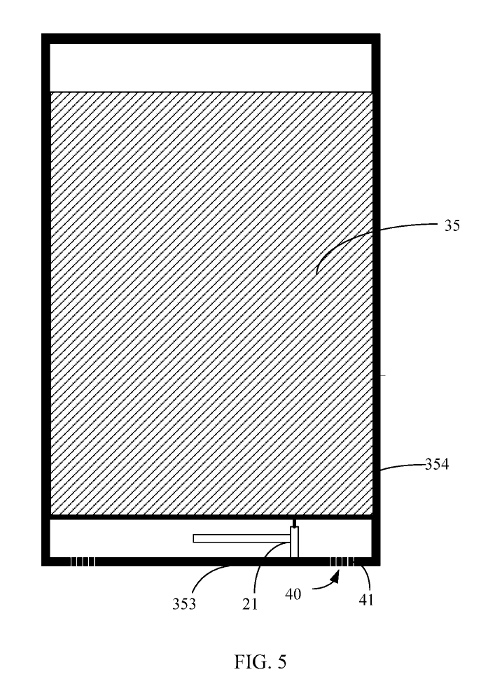

Further, referring to FIG. 4, in a second embodiment of the present disclosure, there are two micro gap sets, and the micro gap sets divide the metal housing to form two metal regions that are completely separated. In this embodiment, the metal housing 35 is a peripheral frame of the electronic apparatus. The two micro gap sets 40 include more than two micro gaps 41. The two micro gap sets 40 are disposed at intervals to divide the peripheral frame, so as to form the metal regions 351 and 352. The antenna main body 21 is connected to the metal region 351. The metal region 351 serves as a radiating body of the antenna main body 21 to implement an antenna function. Referring to FIG. 5, in another form of this embodiment, the metal housing 35 is a peripheral frame connected to a metal back cover. The two micro gap sets 40 divide the metal housing 35 to form metal regions 353 and 354. The antenna main body 21 is connected to either of the metal regions, which increases an area of the antenna main body 21, so as to improve performance of the antenna.

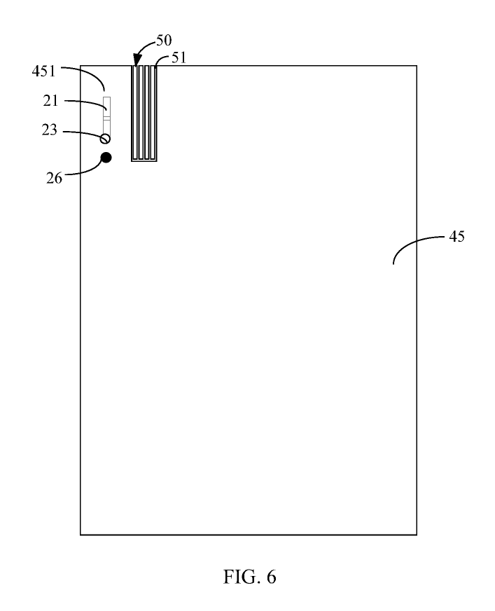

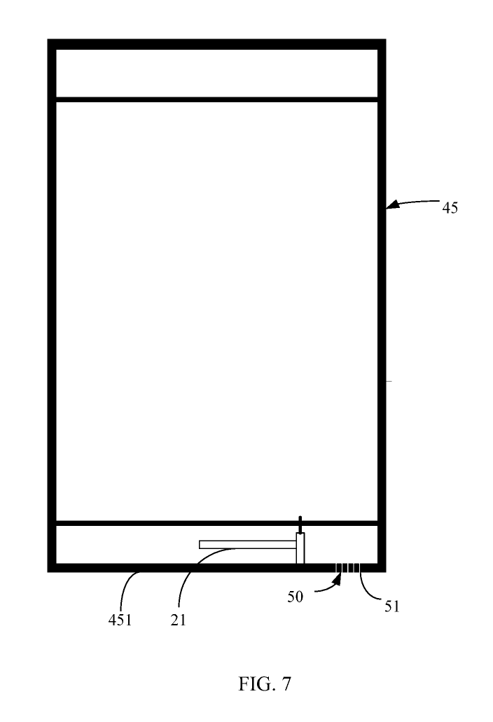

Further, in a third embodiment of the present disclosure, there is one micro gap set, and the micro gap set partially divides the metal housing to form one metal region. Referring to FIG. 6, the metal housing 45 is a back cover of the electronic apparatus. The micro gap set 50 includes more than two micro gaps 51. The micro gap set 50 is disposed at a corner that is on the metal housing 45 and is close to the antenna main body 21, so that the metal housing 45 becomes a metal region 451 partially partitioned by the micro gap set 50. The antenna main body 21 is further provided with a ground point 26, and the ground point 26 is disposed on the metal region 451 on one side of the micro gap set 50. Referring to FIG. 7, in another manner of this embodiment, the metal housing 45 is a peripheral frame, and the micro gap set 50 partitions the peripheral frame.

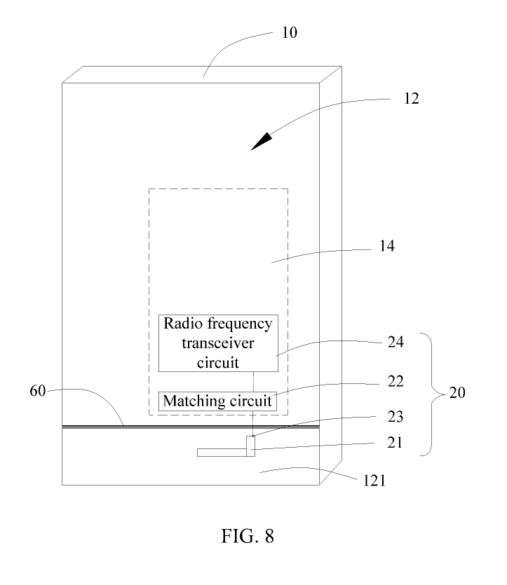

Referring to FIG. 8, a fourth exemplary embodiment of the present disclosure provides an integrated structure of a metal housing and an antenna of an electronic apparatus, which includes an electronic apparatus 10. The electronic apparatus 10 includes a metal housing 12, a circuit board 14, and an antenna structure 20. The antenna structure 20 includes an antenna main body 21. At least one micro gap set 60 is disposed on the metal housing 12. The at least one micro gap set 60 includes micro gaps. The micro gap set 60 divides the metal housing 12 to form at least one metal region 121.

A difference between this embodiment and the foregoing three implementation manners lies in that: the at least one metal region 121 is connected to ground of the circuit board 14 of the electronic apparatus 10, to serve as reference ground of the antenna main body 21. Implementation manners of the micro gap set 60 and the metal housing 12 include the implementation manners in the foregoing three embodiments, and details are not described by using examples herein again. According to this embodiment of the present disclosure, the integrated structure of a metal housing and an antenna of an electronic apparatus is applied to a terminal, and because more electronic elements are mounted in the integrated structure of a metal housing and an antenna of an electronic apparatus, space of the terminal is saved. The following descriptions are exemplary implementation manners of the present disclosure. It should be noted that a person of ordinary skill in the art may make certain improvements and polishing without departing from the principle of the present disclosure and the improvements and polishing shall fall within the protection scope of the present disclosure.

1. An electronic apparatus comprising:
metal housing; and
an antenna structure comprising:
an antenna main body; and
a first micro gap set disposed on the metal housing, comprising first micro gaps, and dividing the metal housing to form a first metal region,
wherein the first metal region is connected to the antenna main body to serve as a radiating body of the antenna structure.

2. (canceled)

3. The electronic apparatus of claim 1, is further comprising a second micro gap set, wherein the first micro gap set and the second micro gap set divide the metal housing into the first metal region, a second metal region, and a third metal region.

4. The electronic apparatus of claim 1, further comprising a second micro gap set, wherein the first micro gap set and the second micro gap set divide the metal housing to form the first metal region and a second metal region.

5. (canceled)

6. The electronic apparatus of claim 3, wherein the metal housing is a back cover, a front housing, or a back cover having a metal frame, and wherein the first micro gap set and the second micro gap set laterally or longitudinally run through the metal housing to divide the metal housing into the first metal region, the second metal region, and the third metal region.

7. The electronic apparatus of claim 4, wherein the metal housing is a peripheral frame of the electronic apparatus or a peripheral frame connected to a metal back cover, and wherein the first micro gap set and the second micro gap set are disposed at intervals to divide the peripheral frame into the first metal region and the second metal region.

8. (canceled)

9. The electronic apparatus claim 1, wherein the antenna structure further comprises:
a radio frequency transceiver circuit, and
a matching circuit located between, and electrically connected to, the radio frequency transceiver circuit and the antenna main body.

10. The electronic apparatus of claim 1, wherein the antenna structure further comprises a feed point disposed on the antenna main body.

11. The electronic apparatus of claim 1, wherein the first micro gap set is formed by arranging the first micro gaps at intervals.

12. The electronic apparatus of claim 1, wherein the first micro gap set is formed by crosswise disposing the first micro gaps.

13. The electronic apparatus of claim 11, further comprising a non-metal material filling in the first micro gaps.

14. The electronic apparatus according to claim 1, wherein a width of one of the first micro gaps is less than 0.5 millimeters.

15. The electronic apparatus of claim 1, wherein the antenna main body and the metal region are configured to connect using a metal dome or a screw.

16. An electronic apparatus comprising:
a circuit board comprising a ground;
a metal housing; and
an antenna structure comprising:
an antenna main body; and
a first micro gap set disposed on the metal housing, comprising first micro gaps, and dividing the metal housing to form a first metal region,
wherein the metal region is connected to the ground.

17. The electronic apparatus of claim 16. wherein the first micro gap set divides the metal housing into the first metal region and a second metal region.

18. The electronic apparatus of claim 17, wherein the metal housing is a hack cover, a front housing, or a back cover having a metal frame, and wherein the first micro gap set laterally or longitudinally runs through the metal housing to divide the metal housing into the first metal region and the second metal region.

19. The electronic apparatus of claim 16, wherein the antenna structure further comprises:
a radio frequency transceiver circuit; and
a matching circuit located between, and electrically connected to, the radio frequency transceiver circuit and the antenna main body.

20. The electronic apparatus of claim 16, wherein the antenna structure further comprises a feed point disposed on the antenna main body.

21. The electronic apparatus of claim 16, wherein the first micro gap set is formed by arranging the first micro gaps at intervals.

22. The electronic apparatus of claim 21, further comprising a non-metal material filling in the first micro gaps.

23. The electronic apparatus of claim 16, wherein a width of one of the first micro gaps is less than 0.5 millimeters.
